(19) United States
(12) Patent Application Publication
(10) Pub. No.: US 2007/0158998 A1
(43) Pub. Date: Jul. 12, 2007

(54) Motorcycle hub adaptor method and apparatus

(76) Inventor: Mathew Randolph Aron, San Diego, CA (US)

Correspondence Address: PETER MARTINEZ, P.O. BOX 131313, CARLSBAD, CA, 92013, US

(21) Appl. No.: 11/373,006

(22) Filed: Mar. 10, 2006

Related U.S. Application Data
(60) Provisional application No. 60/756,759, filed on Jan. 6, 2006.

(51) Int. Cl. B60B 27/00

(52) U.S. Cl. 301/110.5

(57) ABSTRACT

The present invention hub adaptor enables different sized components to be quickly and easily mounted to a motorcycle hub, regardless of the respective diameters of the mating components. In addition, the hub adaptor also may be used to ensure proper alignment between the drive sprocket, or pulley and the driven sprocket or pulley, thereby maximizing drive chain, or belt life. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

This application claims priority from U.S. Provisional Application Ser. No. 60/756,759, filed Jan. 6, 2006, entitled “Motorcycle Hub Assembly Method and Apparatus”, which is incorporated herein by reference in its entirety.

### FIELD OF THE INVENTION

The present invention generally relates to motorcycles. More particularly, the invention concerns a motorcycle hub adaptor.

### BACKGROUND OF THE INVENTION

Motorcycle wheel assemblies generally comprise a central cylindrical element called a “hub” that has a dual function, namely to anchor a plurality of spokes or other wheel supporting elements that are attached to a peripheral rim that supports a tire thereabout and also holds and receives the brake rotor (front wheel assembly) and mounts a brake rotor and a drive sprocket or pulley in the case of a rear wheel assembly. The hub generally contains axle support bearings and associated seals that surround an axle on which the hub, and remaining wheel assembly turns. Hubs are made in one, two or more pieces that are generally designed individually for each manufacturer and/or for each type of motorcycle.

For example, one manufacturer may make a hub that employs sealed roller bearing assemblies, and another may use needle bearings. These and other design differences result in different hub dimensions, such as the circular flange onto which the driven sprocket or pulley may mount. These design differences can negatively impact the interchangeability between the wheel assembly components such as the brake rotor, and the driven pulley or sprocket.

The lack of interchangeability can be the source of much frustration for the motorcycle owner interested in modifying or individualizing his motorcycle. For example, motorcycle manufacturers have seized upon the recent surge in popularity and have been selling motorcycles and accessories in record numbers. Accompanying the increasing sales trend is the associated trend of modification, which appeals to the individualistic nature of motorcyclists. Motorcycle “mods” range from simple replacement of stock or original parts with “chromed” versions, to extensive engine, chassis, and wheel assembly modifications.

However, many times a desired component cannot be fitted, or cannot be easily fitted, to the motorcycle because of incompatibility between the new component and the motorcycle part that it attaches to. One example is the desire to fit wider tires, or different sprockets, pulleys or brake components onto the rear wheel assembly. Invariably, incompatibility problems almost always arise between the desired new component and the old.

Therefore, there remains a need to overcome one or more of the limitations in the above-described, existing art.

### BRIEF DESCRIPTIONS OF THE DRAWINGS

FIG. 1 is an exploded perspective view of one embodiment of the present invention and also includes a perspective view of a motorcycle hub and a motorcycle component;

FIG. 2 is a cross-sectional view of the embodiment illustrated in FIG. 1, with the primary hub adaptor and two adaptor rings removeably coupled together;

FIG. 3A is a plan view of the primary adaptor illustrated in FIG. 1, constructed according to one embodiment of the present invention;

FIG. 3B is a cross-sectional view taken through cutting plane 3B-3B of the embodiment of the primary adaptor illustrated in FIG. 3A;

FIG. 4A is a plan view of an adaptor ring illustrated in FIG. 1, constructed according to one embodiment of the present invention; and

FIG. 4B is a cross-sectional view taken through cutting plane 4B-4B of the embodiment of the primary adaptor illustrated in FIG. 4A.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention.

The present invention provides a method and apparatus that eliminates interchangeability problems between motorcycle components that previously could not be coupled, or mounted together. Generally, motorcycle hubs include a circular flange located around a bearing assembly that allows the hub to rotate about the axle. Wheel assembly components, such as brake rotors, and driven sprockets or driven pulleys have centrally-located mounting apertures, or openings that are sized to closely fit around the hub flange, thus ensuring that the components are rotationally centered. The various wheel assembly components are then bolted or otherwise coupled to the hub.

Interchangeability problems arise when the outer diameter of the hub flange is different than the inner diameter of the mounting aperture on the brake rotor, or driven pulley or other desired component. Another interchangeability problem arises when mounting a desired wheel assembly component causes mis-alignment between the motorcycle drive pulley or sprocket and the driven pulley or sprocket mounted on the wheel assembly. And yet another interchangeability problem arises when mounting a wider rear tire to the wheel assembly. In this case, the wider tire may rub against the drive chain or pulley, causing an unsafe operating condition.

The present invention overcomes all of the above described problems by providing hub adaptor method and apparatus. In one embodiment, the apparatus may comprise a primary adaptor structured to removeably couple to the motorcycle hub that includes a cylindrical recess having a diameter sized to receive a motorcycle hub flange, and opposite the recess, a primary adaptor flange sized to fit within the central aperture of a motorcycle component. In this embodiment, the diameters of the cylindrical recess and the primary adaptor flange are not equal.

Another embodiment of the present invention comprises a primary adaptor and at least one adaptor ring structured to removeably couple to the primary adaptor. The adaptor ring is sized to fit within the cylindrical recess of the primary adaptor, thereby changing the diameter of the cylindrical recess. Alternatively, the adaptor ring may be installed around the primary adaptor flange, changing the diameter of the primary adaptor flange.

Another embodiment of the present invention comprises a primary adaptor and two adaptor rings structured to removeably couple to the primary adaptor. One adaptor ring fits within the cylindrical recess and the second adaptor ring surrounds the primary adaptor flange.

The modular hub adaptor may also position a driven pulley or sprocket farther away from the wheel assembly, thereby moving the drive belt or chain away from the rear tire, and thus enabling a wider-than-stock tire, or other components to be mounted to the wheel assembly.

Motorcycles have been in production for over 100 years, built by manufacturers such as Aprilla, BMW, Buell, Ducati, Harley-Davidson, Honda, Indian, Kawasaki, Moto Guzzi, Suzuki, Triumph, Victory, Yamaha, and others. It will be appreciated that the present invention may be installed on any motorcycle built by the above-listed manufacturers, or other un-named manufacturers (some, or all of the above-listed manufacturer names may be registered trademarks of their respective owners).

One manufacturer that has become very popular in the United States, as well as throughout the world, is Harley-Davidson. Harley-Davidson manufactures many different models of motorcycles, which may be generally categorized into five different types: Touring models, Softail models, Sportster models, Dyna Glide models, and V-Rod models (Harley-Davidson is a registered trademark of H-D Michigan, Inc., of Ann Arbor Mich.).

For example, touring models may include the FLHT Electra Glide standard, FLHTC Electra Glide classic, FLHTCU Ultra Classic Electra Glide, FLHTP Electra Glide police, FLHS Electra Glide sport, FLHR Road King, FLHRC Road King classic, FLHP Road King police, FLTC Tour Glide classic, FLTCU Ultra classic tour Glide, FLTR Road Glide, FLHRS Road King custom, FLHRI Road King, FLHRSI Road King custom, FLHRCI Road King classic, FLTRI Road Glide, FLHTI Electra Glide standard, FLHTCI Electra Glide classic, and the FLHTCUI Ultra Classic Electra Glide (some or all of the above model names may be registered trademarks of H-D Michigan, Inc., of Ann Arbor Mich.).

Sportster models may include the Sportster XL883, Sportster XL883L, Sportster XL883C, Sportster XL883C custom, Sportster XL883R, Sportster XLH883, Sportster XLH883 Hugger, Sportster XLH883 Deluxe, Sportster XL1200C, Sportster XL1200C custom, Sportster XL1200R, Sportster XL1200R Roadster, Sportster XLH1200, and the Sportster 1200S Sport (some or all of the above model names may be registered trademarks of H-D Michigan, Inc., of Ann Arbor Mich.).

Dyna Glide models may include the FXD Dyna Super Glide, FXDX Dyna Super Glide sport, FXDXT Dyna Super Glide T-sport, FXDL Dyna Low Rider, FXDP Dyna Defender, FXDS-CONV Dyna Convertible, FXDWG Dyna Wide Glide, FXDC/I Super Glide Custom, FXDI Dyna Super Glide, FXDXI Dyna Super Glide sport, FXDCI Super Glide custom, FXDLI Dyna Low Rider, and the FXDWGI Dyna Wide Glide (some or all of the above model names may be registered trademarks of H-D Michigan, Inc., of Ann Arbor Mich.).

V-Rod models may include the VRSCA V-Rod, VRSCB V-Rod, and the VRSCR Street Rod (some or all of the above model names may be registered trademarks of H-D Michigan, Inc., of Ann Arbor Mich.).

Softail models may include the FXST Softail Standard, FXSTI Softail Standard, FXSTB Night Train, FXSTBI Night Train, FXSTSI Springer Softail, FXSTDI Deuce, FLSTF Fat Boy, FLSTFI Fat Boy, FLSTFI Fat Boy 15^{th} Anniversary Special Edition, FLSTNI Softail Deluxe, FLSTSCI Softail Springer Classic, FLSTC Heritage Softail Classic, FLSTCI Heritage Softail Classic, FLSTN Heritage Softail Special, FLSTS Heritage Springer, FXSTC Softail Custom, FXSTD Softail Deuce, FXSTS Springer Softail, and the FXSTSB Bad Boy (some or all of the above model names may be registered trademarks of H-D Michigan, Inc., of Ann Arbor Mich.).

Clearly, Harley-Davidson manufactures many different motorcycle models. It will be appreciated that the present invention may be installed on any of the above-listed models, or on other models yet to be manufactured. In addition, the present invention may be installed on a “custom” motorcycle, which is a motorcycle that differs from a manufacturer-produced model. For example, a custom motorcycle may be a Harley-Davidson FXST Softail Standard that has had specific parts that are either added, removed or modified. Or, a custom motorcycle may be built from scratch, using no, or very few pre-manufactured parts, such as only the engine, transmission and tires.

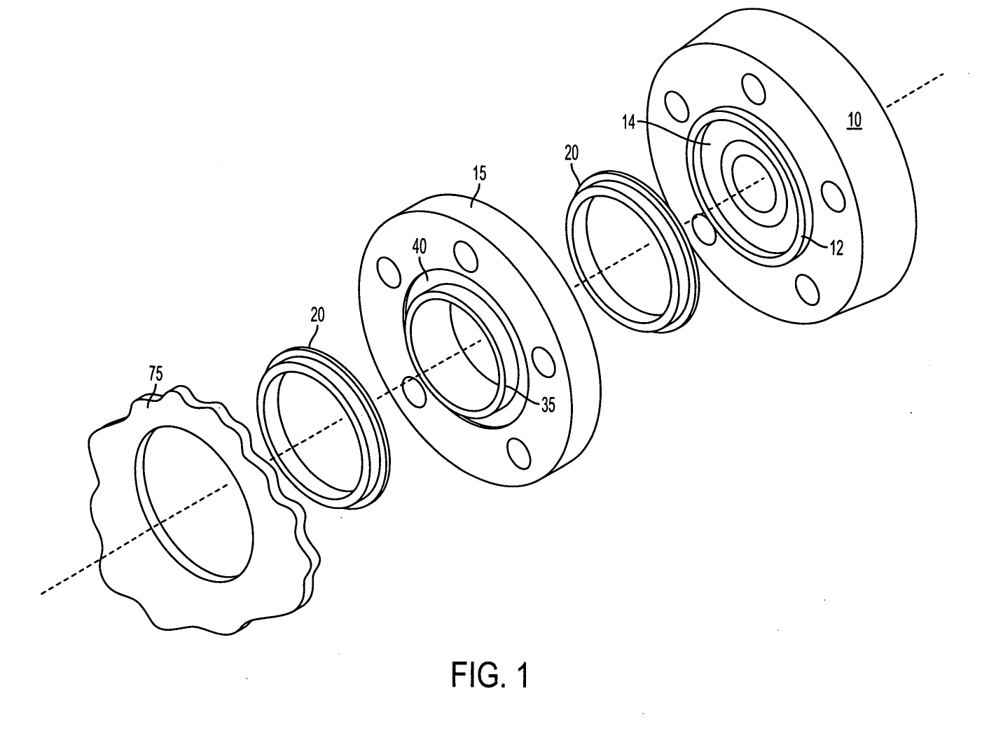

Referring to FIG. 1, a hub adaptor apparatus for mounting to a motorcycle hub 10 is illustrated. In one embodiment the hub adaptor apparatus may include just the primary adaptor 15, or depending upon the mating components, the hub adaptor apparatus may also include one, or both adaptor rings 20.

As shown in FIG. 1, the motorcycle hub 10 includes a hub flange 12 that encircles a bearing assembly 14. Depending on the motorcycle manufacturer, and/or the year the motorcycle was constructed, the hub flange 12 may vary in outer diameter. For example, some motorcycle hubs 10 use sealed roller bearing assemblies that, depending on the bearing assembly, require a hub flange 12 that has an outer diameter that is greater than other motorcycle hubs 10 that use non-sealed bearing assemblies. As an example, Harley-Davidson, from around 1930 to 1999, manufactured rear hub assemblies using non-sealed bearings with a hub flange 12 having an outer diameter of about 1.9 inches (sometimes referred to as “old hub”). For motorcycles manufactured in 2000 to the present day, Harley-Davidson changed to a sealed roller bearing assembly in the rear hub, resulting in a hub flange 12 outer diameter of about 2.1 inches (sometimes referred to as “new hub”).

Thus, when a motorcycle owner wishes to modify his or her motorcycle, by mounting a new wider rear tire, or a different driven sprocket or pulley, or brake disk, the new component may not mate to the hub flange 12 on his or her motorcycle as it may be sized to fit the other hub flange diameter. To keep the owner from regretfully abandoning the desired modification, various embodiments of the present invention may be employed.

The present invention hub adaptor apparatus enables different sized components to be quickly and easily mounted to the motorcycle hub 10, regardless of the respective diameters of the hub flange, or the mating components. In addition, the hub adaptor apparatus also may be used to ensure proper alignment between the drive sprocket, or pulley and the driven sprocket or pulley, thereby maximizing drive chain, or belt life. For example, as shown in FIG. 1, a motorcycle component 75 may be a brake disk, a driven sprocket or a driven pulley.

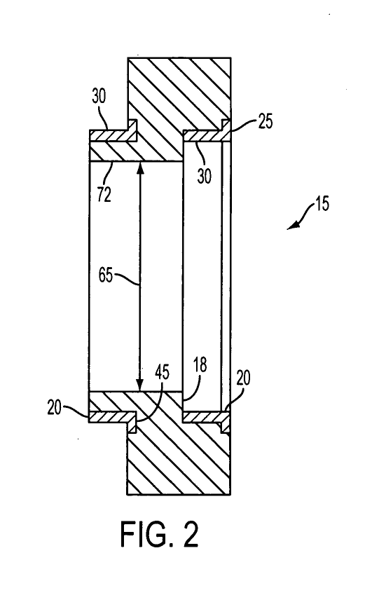

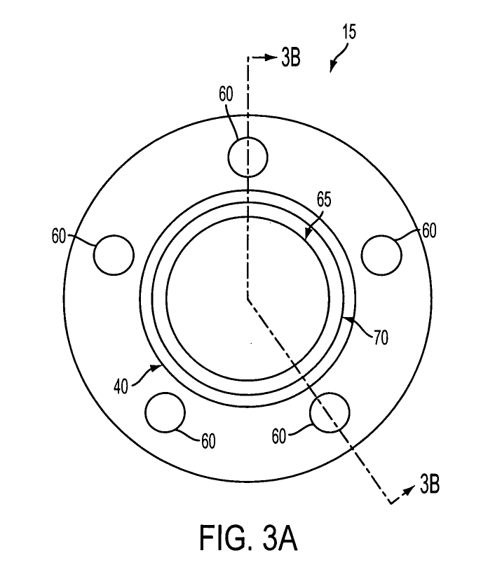

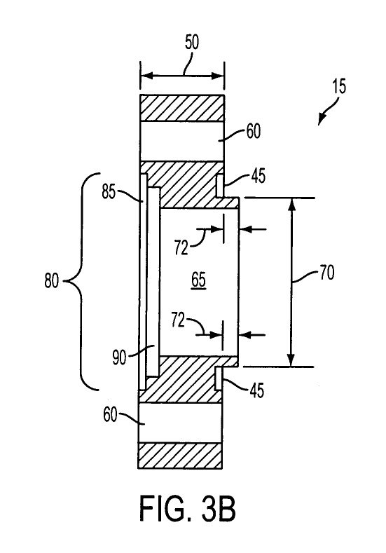

Referring now to FIGS. 2 and 3A-B, the primary adaptor 15 is illustrated. As shown in the figures, the primary adaptor 15 includes several fastener apertures 60 for receiving fasteners, such as bolts, studs or other types of fasteners used to removeably couple the primary adaptor 15 to the motorcycle hub 10. The primary adaptor 15 has a central aperture 65 that in some embodiments may be sized to receive the hub flange 12, or in other embodiments may be smaller in inner diameter than the hub flange 12, depending on the primary adaptor width 50. For example, in embodiments that require the primary adaptor 15 to perform as a hub adaptor and/or as a spacer for eliminating interference between, say, a wider rear wheel and a drive chain or belt, the hub flange 12 may abut, or closely abut the hub flange shelf 18 illustrated in FIG. 2.

In other embodiments, the central aperture 65 may be sized to closely surround the hub flange 12 outer diameter. In these embodiments, the primary adaptor 15 may have a primary adaptor width 50 sized to provide alignment between the drive chain, or pulley (not shown) with the driven chain or pulley, illustrated as motorcycle component 75 in FIG. 1. Thus, the primary adaptor width 50 may range from about 0.075 inches to more than 2 inches. The primary adaptor 15 may be constructed from metal, plastic, or an alloy, such as aluminum.

Referring again to FIGS. 2 and 3A-B, surrounding the primary adaptor central aperture 65 is the primary adaptor flange 72, having a primary adaptor flange outer diameter 70. In one embodiment, the primary adaptor flange outer diameter 70 is sized to fit “old hubs” or alternatively, “new hubs” having a larger diameter, as described above.

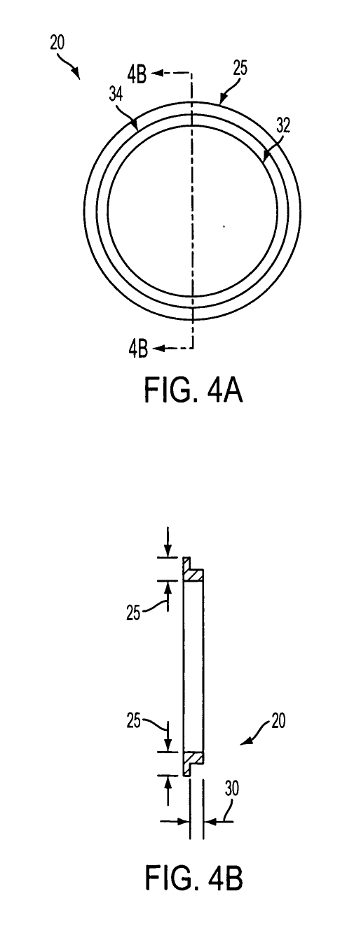

In a preferred embodiment, the primary adaptor flange outer diameter 70 is sized to fit the “old hubs” (i.e., smaller diameter) and includes an annular recess 45 located at the base of the primary adaptor flange 72. As shown in FIG. 2, the annular recess 45 is sized to receive a circular, or ring adaptor pedestal 25 of the adaptor ring 20. When the adaptor ring 20 is placed about the primary adaptor flange 72, the adaptor ring flange 30 surrounds the primary adaptor flange 72. In one embodiment, the adaptor ring flange, or mating flange outer diameter 34 (shown in FIG. 4A) is sized to receive a motorcycle component 75 having a central aperture sized to the “new hub” diameter. Thus, by attaching the primary adaptor 15 to an “old hub” and fitting the adaptor ring 20 to the primary adaptor 15, a motorcycle component 75, such as a brake disk, driven pulley or driven sprocket having a central aperture sized to the “new hub” diameter may be attached to an “old hub” flange having a smaller diameter.

As shown in FIGS. 2 and 3B, on the other side, or opposite the primary adaptor flange 72, the face of the primary adaptor 15 that directly contacts the hub 10 includes a stepped recess 80 having a first circular depression 85 and a second circular depression 90. Each of the circular depressions 85, 90 are concentric to the central aperture 65, with the first circular depression 85 sized to receive the circular pedestal 25 of the adaptor ring 20, and the second circular depression 90 sized to receive the adaptor ring mating flange 30 of adaptor ring 20.

When the adaptor ring 20 is placed within the stepped recess 80, with the adaptor ring mating flange 30 positioned in the second circular depression 90, and the circular pedestal 25 positioned in the first circular depression 85, the primary adaptor 15 can be placed over an “old hub” having a smaller diameter hub flange 12. This is because the mating flange inner diameter 32 is approximately the same diameter as the “old hub” hub flange 12. As shown in FIG. 2, in a preferred embodiment, no part of the adaptor ring 20 extends from the primary adaptor 15 when the adaptor ring 20 is positioned in the stepped recess 80.

Referring now to FIGS. 4A-B, the adaptor ring 20 includes a circular pedestal or base 25 with a mating flange 30 extending therefrom. The mating flange inner diameter 32 is sized to surround the primary adaptor flange 72 (shown in FIG. 3B), with the circular pedestal 25 sized to fit within the adaptor ring recess 45. This is because the diameter of the circular pedestal 25 is the same as the outer diameter 40 of the adaptor ring recess 45 (shown in FIG. 3A).

As discussed above, with the adaptor ring 20 fitted around the primary adaptor flange 72, the mating flange outer diameter 34 is sized to receive a motorcycle component 75 having a central aperture sized to the “new hub” diameter.

Thus, with reference to FIG. 2, and the above disclosure, the primary adaptor 15 and one or more adaptor rings 20 may be used to removeably couple motorcycle components to hubs regardless of their compatibility. For example, when a brake disk having a “new hub” diameter must be fitted to an “old hub” flange, both adaptor rings 20 are fitted to the primary adaptor 15, thereby creating a larger diameter flange for receiving the brake disk, and a smaller diameter within the stepped recess 80 for receiving the smaller diameter “old hub” flange.

Alternatively, when fitting a driven sprocket (i.e., motorcycle component) having a central aperture sized to fit an “old hub” flange to a “new hub” flange having a larger diameter, no adaptor rings 20 are necessary, as the primary adaptor 15 second circular depression 90 has a diameter similar to the “new hub” flange diameter, and the primary adaptor flange 72 has an outer diameter similar to the “old hub” flange diameter.

Yet another combination is when, for example, a driven pulley (i.e., motorcycle component) having a central aperture sized to fit an “old hub” flange is to be mounted to an “old hub”. In this case the respective diameters are compatible, but the motorcycle has been modified by installation of a wider tire, causing the drive belt to rub on the tire. In this case, the primary adaptor 15 functions as a spacer to move the driven pulley away from the tire, eliminating any interference.

It will be appreciated that all of the diameters, discussed above, such as “old hub” and “new hub” and diameters on either the primary adaptor 15 or on the adaptor ring 20 may be altered to fit motorcycles constructed by different manufacturers, or motorcycles yet to be constructed.

For the purposes of interpreting words used in the claims, it is to be noticed that the term “comprising”, should not be interpreted as being limitative to the claim elements listed thereafter. Thus, the scope of the expression “a device comprising elements A and B” should not be limited to devices consisting only of components A and B. It means that with respect to the present invention, the only relevant components of the device are A and B.

Similarly, it is to be noticed that the term “coupled”, also used in the claims, should not be interpreted as meaning attached or joined together, but not limitative to direct connections only. Thus, the scope of the expression “a element A coupled to an element B” should not be limited to devices or systems wherein element A is directly connected to element B. It means that there exists a path between A and B which may be a path including other elements or means. The term “removeably coupled” means that the elements A and B, if directly attached or joined together, may also be un-attached or separated apart from one another.

Thus, it is seen that a motorcycle hub adaptor is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A modular hub adaptor kit for a motorcycle hub, the kit comprising:
a primary adaptor structured to removeably couple to the motorcycle hub, the primary adaptor including a central aperture surrounded by a primary adaptor flange; and
a first adaptor ring structured to removeably couple to the primary adaptor, the first adaptor ring including a mating flange structured to surround an outer diameter of the primary adaptor flange.

2. The modular hub adaptor kit of claim 1, where the primary adaptor further comprises a stepped recess located substantially opposite the primary adaptor flange, the stepped recess also sized to receive the first adaptor ring.

3. The modular hub adaptor kit of claim 1, further comprising a second adaptor ring, the second adaptor ring sized substantially identically to the first adaptor ring so that either adaptor ring can be interchangeably positioned about the primary adaptor flange or within the stepped recess opposite the primary adaptor flange.

4. The modular hub adaptor kit of claim 1, where the primary adaptor further comprises;
a circular plate including the central aperture surrounded by the primary adaptor flange;
an annular recess located at a base of the primary adaptor flange, the annular recess sized to receive a circular pedestal of the first adaptor ring;
the stepped recess located substantially opposite the primary adaptor flange, the stepped recess also sized to receive the first adaptor ring; and
at least four fastener openings on the circular plate for removeably coupling the primary adaptor to the motorcycle hub.

5. The modular hub adaptor kit of claim 1, where the first adaptor ring further comprises:
a circular pedestal having the mating flange extending therefrom, the circular pedestal sized to removeably couple into an annular recess located at a base of the primary adaptor flange, with the mating flange sized to surround the outer diameter of the primary adaptor flange, and having a substantially same flange height as the primary adaptor flange.

6. The modular hub adaptor kit of claim 1, where the primary adaptor further comprises a stepped recess located substantially opposite the primary adaptor flange, the stepped recess comprising at least two circular depressions located concentric to the central aperture, the first circular depression sized to receive a circular pedestal of the first adaptor ring, and the second circular depression sized to receive the mating flange of first adaptor ring.

7. The modular hub adaptor kit of claim 1, where the primary adaptor flange and the mating flange are sized to receive a motorcycle component selected from a group consisting of: a brake rotor, a driven pulley and a driven sprocket.

8. The modular hub adaptor kit of claim 1, where the primary adaptor comprises a circular plate having a width that can range from 0.075 inches to 2.0 inches.

9. A hub adaptor for a motorcycle hub, comprising:
a circular plate having a central aperture surrounded by an adaptor flange;
an annular recess located at a base of the adaptor flange;
a stepped recess located substantially opposite the adaptor flange, the stepped recess comprising at least two circular depressions located concentric to the central aperture; and
at least four fastener openings on the circular plate for removeably coupling the hub adaptor to the motorcycle hub.

10. The hub adaptor of claim 9, further comprising at least one hub adaptor ring comprising a circular pedestal and a ring flange extending from the circular pedestal, the hub adaptor ring sized to fit either within the stepped recess or within the annular recess with the ring flange surrounding the adaptor flange.

11. The hub adaptor of claim 9, further comprising a hub adaptor ring structured to removeably couple to the hub adaptor, the hub adaptor ring including a ring flange structured to surround an outer diameter of the adaptor flange.

12. The hub adaptor of claim 9, where the adaptor flange is sized to receive a motorcycle component selected from a group consisting of: a brake rotor, a driven pulley and a driven sprocket.

13. The hub adaptor of claim 10, where the ring flange is sized to receive a motorcycle component selected from a group consisting of: a brake rotor, a driven pulley and a driven sprocket.

14. The hub adaptor of claim 9, where the hub adaptor comprises a circular plate having a width that can range from 0.075 inches to 2.0 inches.

15. A modular hub adaptor kit, the kit comprising:
a primary adaptor structured to removeably couple to a motorcycle hub, the primary adaptor comprising a central aperture surrounded by a motorcycle component mating flange with a stepped recess opposite the mating flange;
at least one adaptor ring structured to removeably couple about the mating flange or within the stepped recess.

16. The modular hub adaptor kit of claim 15, wherein the adaptor ring changes a diameter of the mating flange or the stepped recess.

17. The modular hub adaptor kit of claim 15, where the at least one adaptor ring comprises:
a circular pedestal having a ring flange extending therefrom, the circular pedestal sized to removeably couple into an annular recess located at a base of the motorcycle component mating flange, with ring flange sized to surround the outer diameter of the motorcycle component mating flange, and having a substantially same flange height as the motorcycle component mating flange.

18. The modular hub adaptor kit of claim 15, where the stepped recess comprises at least two circular depressions located concentric to the central aperture, the first circular depression sized to receive a circular pedestal of the at least one adaptor ring, and the second circular depression sized to receive a ring flange of first adaptor ring.

19. The modular hub adaptor kit of claim 15, where the motorcycle component mating flange is sized to receive a motorcycle component selected from a group consisting of: a brake rotor, a driven pulley and a driven sprocket.

20. The modular hub adaptor kit of claim 15, where the primary adaptor comprises a circular plate having a width that can range from 0.075 inches to 2.0 inches.
